(19) United States
(12) Patent Application Publication
(10) Pub. No.: US 2007/0269301 A1
(43) Pub. Date: Nov. 22, 2007

(54) Machine lift

(76) Inventor: David L. Eekhoff, Sioux Center, IA (US)

Correspondence Address: THOMTE LAW OFFICE, L.L.C., 2120 S. 72ND STREET, SUITE 1111, OMAHA, NE, 68124, US

(21) Appl. No.: 11/126,927

(22) Filed: May 11, 2005

(51) Int. Cl. B60P 1/00

(52) U.S. Cl. 414/543

(57) ABSTRACT

A machine lift having a base secured to a vehicle floor adjacent the rearward end thereof at one side thereof. A rotatable pedestal is mounted on the base and extends upwardly therefrom. An elongated lift arm, having inner and outer ends, is pivotally secured to the pedestal and extends outwardly therefrom. An elongated linkage, having inner and outer ends, is pivotally connected at its inner end to the pedestal adjacent the lower end thereof and extends outwardly therefrom. The outer ends of the lift arm and linkage are pivotally connected to a frame which extends upwardly from a horizontally disposed support platform. An elongated screw actuator extends between the pedestal and the lift arm for raising and lowering the platform with respect to the vehicle. The platform may be moved from a position wherein it is positioned on the floor of the vehicle adjacent the other side thereof at the rearward end thereof to a position rearwardly of the vehicle which enables the screw actuator to lower the platform onto the ground rearwardly of the vehicle.

### BACKGROUND OF THE INVENTION

1. Field of the Invention

This invention relates to a machine lift and more particularly to a machine lift which is mounted in the interior of a vehicle compartment or in the bed of a pickup truck which enables a machine or device to be moved from a position rearwardly of the vehicle to a position inside the vehicle interior compartment or pickup box and vice versa.

2. Description of the Related Art

Many different types of lifting devices have been previously provided which enable objects, articles, machines, etc., to be raised from a position rearwardly of a vehicle to a position where the object, article, etc., may be moved onto the vehicle bed or the like. The prior art lifting devices are not believed to be convenient to use and require extensive modification of the existing vehicle.

### SUMMARY OF THE INVENTION

A machine, article or object lift device is disclosed which is used in combination with a vehicle having an interior compartment above a floor which the floor having rearward and forward ends and first and second sides. The interior compartment may either be provided in a van or the box or bed of a pickup truck. A mounting bracket is secured to the vehicle floor adjacent the rearward end thereof and adjacent the first side of the floor. An upstanding, rotatable pedestal extends upwardly from the mounting bracket and has an upper end. An elongated lift arm assembly having inner and outer ends is also provided with the inner end of the lift arm assembly being pivotally mounted, about a horizontal axis, to the pedestal adjacent the upper end thereof. An elongated linkage, having inner and outer ends, is also provided with the inner end of the linkage being pivotally secured, about a horizontal axis, to the pedestal below the inner end of the lift arm assembly.

A horizontally disposed object, article, machine, or device supporting platform, having inner and outer ends and first and second sides, is also included in the invention. An upstanding frame, having its lower end secured to the inner end of the platform, extends upwardly therefrom. The outer end of the lift arm assembly is pivotally secured to the frame about a horizontal axis. The outer end of the linkage is also pivotally secured to the frame, about a horizontal axis, below the connection of the outer end of the lift arm assembly and the frame so that the linkage is substantially parallel to the lift arm assembly. A length adjustable actuator such as an electric screw actuator, having upper and lower ends, is an integral part of the invention with the actuator being movable between extended and retracted positions. The lower end of the actuator is pivotally secured, about a horizontal axis, to the pedestal. The upper end of the actuator is pivotally secured, about a horizontal axis, to the lift arm assembly. Extension of the actuator causes the platform and frame to be raised with respect to the vehicle. Retraction of the actuator causes the platform and frame to be lowered with respect to the vehicle. The lift arm assembly and the linkage have a length such that the platform may be positioned laterally of the mounting bracket and the pedestal on the floor inwardly of the second side thereof. In one embodiment of the invention, the machine lift is positioned within the interior compartment of a van. In another embodiment, the machine lift is positioned in a pickup box adjacent the rearward end and at one side thereof.

It is therefore a principal object of the invention to provide an improved machine lift.

Still another object of the invention is to provide a machine lift which may be mounted in the interior compartment of a van so that a machine or the like may be raised from the ground rearwardly of the vehicle into the rearward end of the interior compartment.

Still another object of the invention is to provide a machine lift of the type described which does not occupy an inordinate amount of space within the interior compartment.

Still another object of the invention is to provide a machine lift of the type described which is easy to operate.

Yet another object of the invention is to provide a machine lift of the type described which is durable in use and refined in appearance.

These and other objects will be apparent to those skilled in the art.

### BRIEF DESCRIPTION OF THE DRAWINGS

FIG. 1 is a partial rear perspective view of a vehicle having the machine lift of this invention mounted thereon with the machine lift being in a stowed position within the interior compartment of the vehicle;

FIG. 2 is a perspective view of the machine lift of this invention with the platform thereof being in a lowered position;

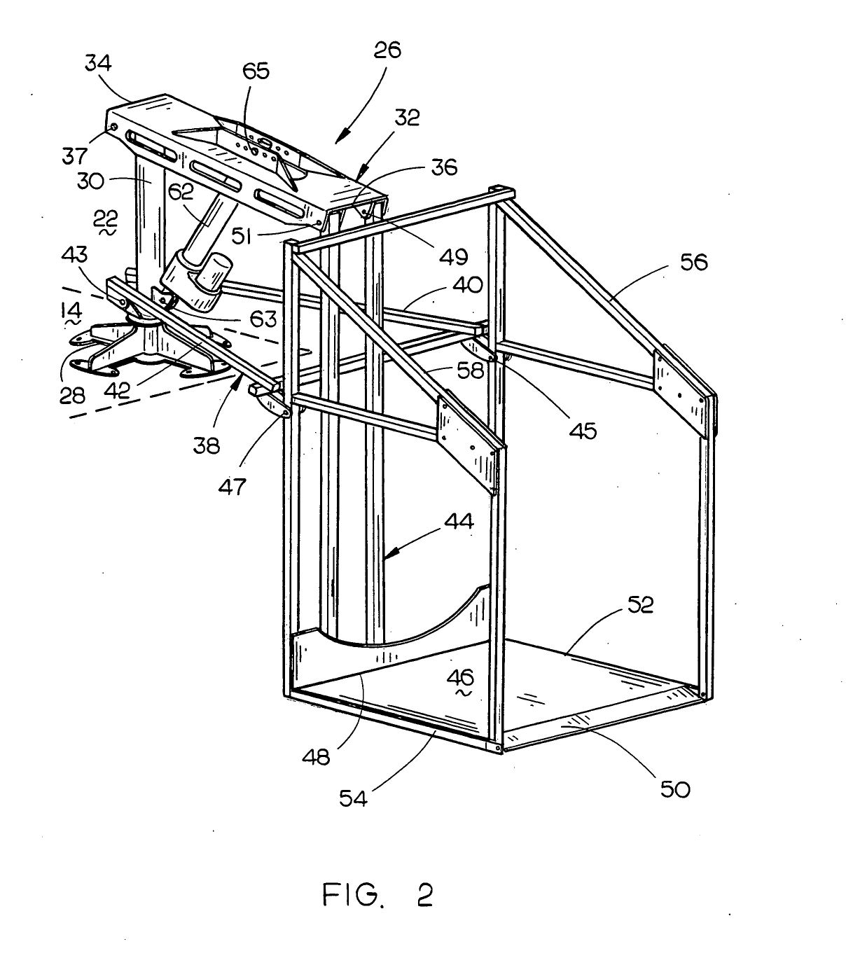

FIG. 3 is a top elevational view illustrating the various positions to which the platform of the machine may be moved; and

FIG. 4 is a side view illustrating the platform of the machine being positioned rearwardly of the vehicle with the broken lines illustrating the position of the platform when in its ground engaging position.

### DETAILED DESCRIPTION OF THE INVENTION

The numeral 10 refers a conventional van having an interior compartment 12, the bottom of which has a floor 14. The vehicle 10 has a door opening 16 at the rearward end thereof which is closable by doors 18 and 20. For purposes of description, the vehicle 10 will be described as also including opposite sides 22 and 24.

Although the invention is referred to as a machine lift, it is well suited for moving articles, objects, machines, devices, etc. from a position rearwardly of the vehicle to a position within the interior compartment of the vehicle and vice versa. Although the invention is being described as being ideally suited for use with a van having an interior compartment 12, the invention of this invention may also be used with a pickup truck having a bed or floor.

The numeral 26 refers to the machine lift of this invention which may not only be used in conjunction with a van 10 but may also be used in conjunction with a pickup truck having a box or bed, as stated above. Machine lift 26 includes a base or mounting bracket 28 which is secured to the floor 14 by bolts or the like at the rearward end of the floor 14 adjacent side 22. A vertically disposed and rotatable pedestal 30 is rotatably mounted on the base 28 and is designed to be manually rotated with respect to base 28 although pedestal 30 could be rotated with respect to base 28 by a gear motor, etc.

The numeral 32 refers to a lift arm or lift arm assembly having an inner end 34 and an outer end 36. The inner end 34 is pivotally secured, about a horizontal axis, to the upper end of pedestal 30 at 37. The numeral 38 refers to a linkage means comprising links 40 and 42 which are pivotally connected at their inner ends to the pedestal 30 about a horizontal axis at 43 below the pivotal connection 37 of the lift arm assembly 32 to the pedestal 30. The outer ends of links 40 and 42 are pivotally connected to an upstanding frame 44 about a horizontal axis at 45 and 47, respectively. The outer end of the lift arm assembly 32 is pivotally connected, about a horizontal axis, at 49 and 51, respectively, to the frame 44 at the upper end thereof. Linkage 38 is parallel to the lift arm assembly 32, as illustrated in the drawings.

The lower end of frame 44 has a horizontally extending platform 46 secured thereto which has an inner end 48, an inclined outer end 50 and opposite sides 52 and 54. The numerals 56 and 58 refer generally to frames positioned on opposite sides of the platform 46 so that the frames 56, 58 and 44 define a cage-like member which surrounds a machine or the like positioned on platform 46 by at least three sides. A strap 60 may be extended between the frames 56 and 58 to maintain whatever object is positioned on the platform 52 within the cage.

A length adjustable actuator 62 is pivotally connected at its lower end, about a horizontal axis, to pedestal 30 at 63. The rod end of the actuator 62 is adjustably pivotally connected to the lift arm assembly 32 about a horizontal axis at 65. Preferably, the length adjustable actuator is an electric screw actuator which is movable between extended and retracted positions. When the rod of actuator 62 is extended, lift arm assembly 32 is raised with respect to the vehicle and also causes platform 46 to be raised. The links 40 and 42, by being parallel to the lift arm assembly 32, cause the platform 46 to remain horizontally disposed as it is raised and lowered with respect to the vehicle.

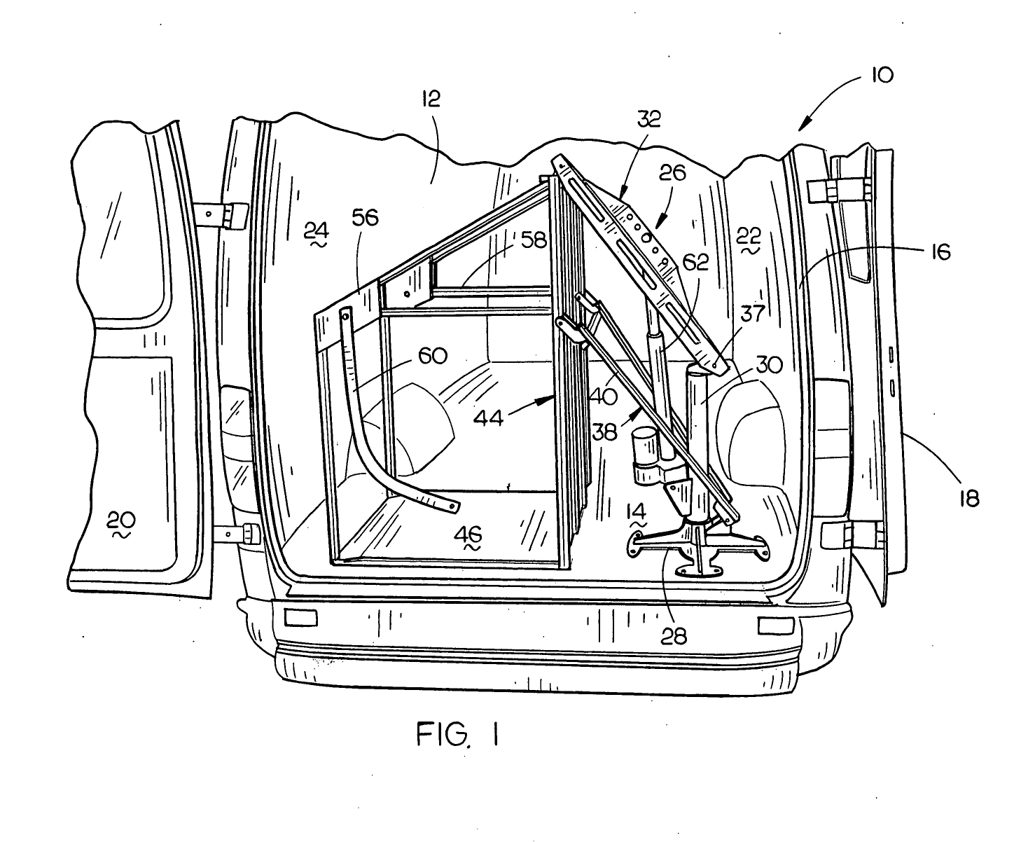

The height of the machine lift 26 is such that it less than the height of the door opening and it is designed so that the distance between the ends of frames 56 and 58 and the mounting bracket 28 is that when the platform 46 is positioned laterally of the base 28, as illustrated in FIG. 1, the entire machine lift is positioned between the side walls 22 and 24 of the interior compartment 12.

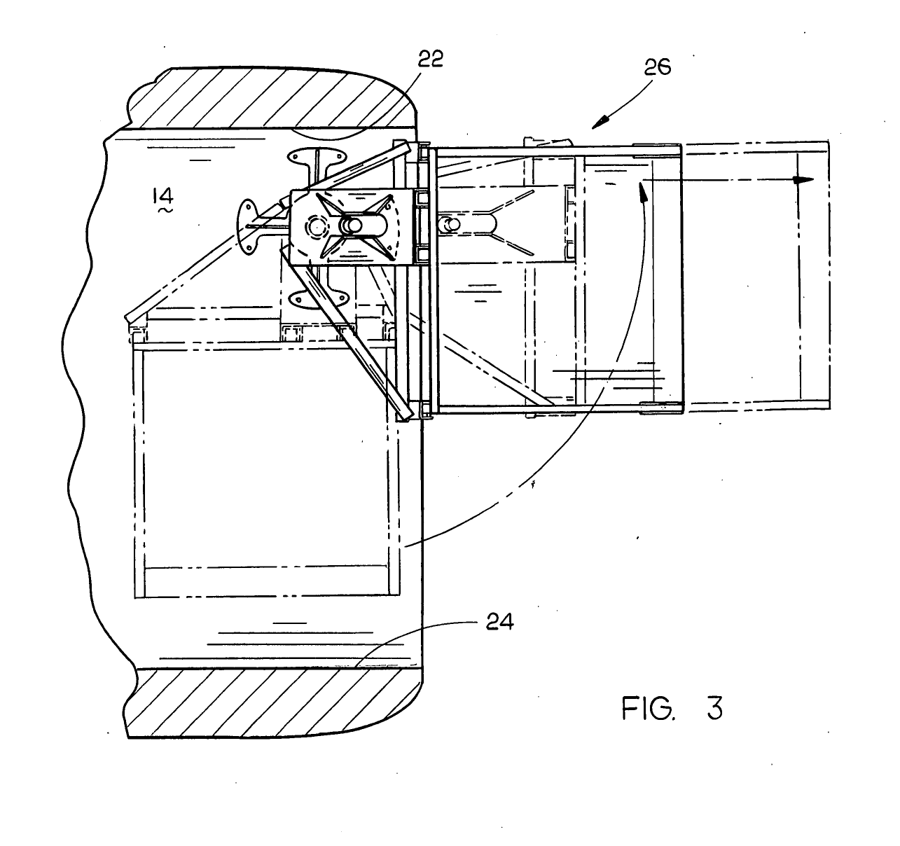

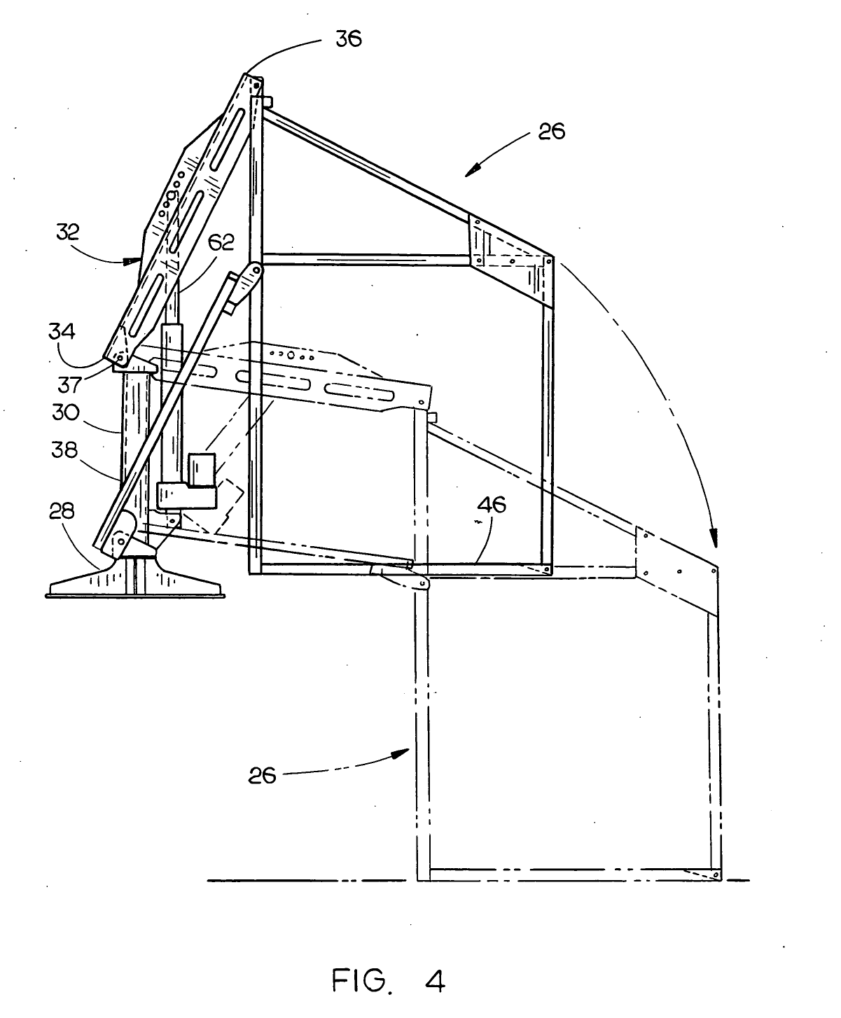

Assuming that the machine lift is in the position of FIG. 1, with the platform 46 resting on the floor 14, and assuming that it is desired to load a machine, article, object, etc., positioned on the ground rearwardly of the vehicle onto the platform and into the vehicle, the actuator 62 is slightly extended so that platform 46 is raised above floor 14. The platform 46 and its associated framework may be then manually pivotally moved with respect to mounting bracket 28 so that the platform 46 is positioned rearwardly of the vehicle as indicated by solid lines in FIGS. 3 and 4. Actuator 62 is then retracted which causes the platform 46 to be swung outwardly and rearwardly from the vehicle 10 and to be lowered onto the ground, as illustrated by broken lines in FIG. 4. The machine, etc., may then be loaded onto the platform 46 and secured within the cage by means of the strap 60. The actuator 62 is then extended so that the platform 46 is raised to a position above the level of the floor 14. The cage is then manually rotated with respect to the pedestal 30 so that the platform 48 is positioned above the rearward end of the floor 14. The actuator 62 is then retracted to lower the platform 46 onto the floor 14.

Although the drawings illustrate that the platform 46 may be positioned laterally of base 28, as seen in FIG. 1, the platform 46 may be further moved forwardly and inwardly from the position of FIG. 1 so that the machine on the platform 46 may be unloaded therefrom into the interior compartment. Such a feature is desirable when two or more of the machines are being used and/or transported.

Thus it can be seen that the invention accomplishes at least all of its stated objectives.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. In combination:
a vehicle having a forward end, a rearward end, a first side, a second side, a floor, a door opening at its rearward end which is selectively closeable by a door, and an interior compartment forwardly of said door opening;
an upstanding rotatable pedestal secured to the floor adjacent the rearward end thereof and adjacent the first side thereof;
said upstanding rotatable pedestal having an upper end;
a parallel lift arm assembly having inner and outer ends;
said inner end of said lift arm assembly being pivotally mounted, about a horizontal axis, to said pedestal;
a horizontally disposed support platform having inner and outer ends and first and second sides;
said outer end of said parallel lift arm assembly being operatively pivotally secured to said platform;
an actuator;
said actuator being secured to said pedestal and said parallel lift arm assembly for raising and lowering said platform;
said parallel lift arm assembly having a length such that said platform may be positioned laterally of said pedestal on the floor of the vehicle inwardly of the second side thereof; and
a generally U-shaped frame extending upwardly from said platform defining a three-sided basket adapted to receive a machine therein.

17. The combination of claim 16 wherein said three-sided basket defines an opening through which a machine may be passed and wherein means is provided for selectively closing said opening.

18. The lifting apparatus of claim 16 wherein the vehicle has an interior compartment having a rear doorway and wherein said platform may be positioned on the floor forwardly of said rear doorway or may be positioned on the ground rearwardly of the vehicle;

19. The lifting apparatus of claim 18 wherein the height of said frame is less than the distance from the vehicle floor to the upper end of the rear doorway; and

20. The lifting apparatus of claim 16 wherein said platform may be selectively moved forwardly and inwardly of its said position laterally of said pedestal to enable an object to be moved from the interior compartment onto said platform and to enable an object positioned on said platform to be moved therefrom into the interior compartment.

21. In combination:
a vehicle having a forward end, a rearward end, a first side, a second side, a floor, a door opening at its rearward end which is selectively closeable by a door, and an interior compartment forwardly of said door opening;
an upstanding rotatable pedestal secured to the floor adjacent the rearward end thereof and adjacent the first side thereof;
said upstanding rotatable pedestal having upper and lower ends;
an elongated lift arm having inner and outer ends;
said inner end of said lift arm being pivotally mounted, about a horizontal axis, to said pedestal at the upper end thereof and extending outwardly therefrom;
first and second elongated links having inner and outer ends;
said inner ends of said links being pivotally secured, about a horizontal axis, to said pedestal below said lift arm and extending outwardly therefrom in a diverging relationship with respect to one another;
said outer ends of said links being spaced apart a distance greater than the width of said outer end of said lift arm;
said links and said lift arm forming a parallel lift arm assembly;
an actuator;
said actuator being pivotably secured to said pedestal and said lift arm and extending therebetween;
a generally U-shaped frame means having upper and lower ends;
said frame means including a platform at said lower end thereof which has an inner end, an outer end, and first and second sides;
said frame means also including a first upstanding side frame having upper and lower ends, a second upstanding side frame having upper and lower ends, and an inner upstanding frame having upper and lower ends;
said lower ends of said first side frame, said second side frame and said inner frame being secured to said first side, said second side and said inner end of said platform to define a three-sided basket to receive a machine therein;
said outer ends of said first and second links being operatively pivotally secured to said first and second side frames of said frame means respectively;
said outer end of said lift arm being pivotably secured, about a horizontal axis, to said inner frame at said upper end;
said lift arm, said first and second links, and said three-sided basket having a length such that said platform may be positioned laterally of said pedestal on the floor of the vehicle inwardly of the second side thereof.

22. The combination of claim 21 wherein the platform may be positioned on the ground rearwardly of the vehicle.
